(19) United States
(12) Patent Application Publication
(10) Pub. No.: US 2017/0117623 A1
(43) Pub. Date: Apr. 27, 2017

(54) MOBILE DEVICE

(71) Applicant: Quanta Computer Inc., Taoyuan City (TW)

(72) Inventors: Ming-Che CHAN, Taoyuan City (TW); Chun-I LIN, Taoyuan City (TW); Hui LIN, Taoyuan City (TW)

(21) Appl. No.: 14/985,933

(22) Filed: Dec. 31, 2015

(30) Foreign Application Priority Data
Oct. 22, 2015 (TW) 104134627

(51) Int. Cl. H01Q 1/44

(52) U.S. Cl. CPC H01Q 1/44

(57) ABSTRACT

A mobile device includes a housing, an antenna element, and a stylus. The stylus includes a metal portion. When the stylus is close to the antenna element, the metal portion resonates with the antenna element in an operation frequency band, so as to enhance the radiation efficiency of the antenna element.

### CROSS REFERENCE TO RELATED APPLICATIONS

This Application claims priority of Taiwan Patent Application No. 104134627 filed on Oct. 22, 2015, the entirety of which is incorporated by reference herein.

### BACKGROUND OF THE INVENTION

Field of the Invention

The disclosure generally relates to a mobile device, and more specifically, to a mobile device for enhancing antenna efficiency.

Description of the Related Art

With the advancements made in mobile communication technology, mobile devices such as portable computers, mobile phones, multimedia players, and other hybrid functional portable devices have become more common. To satisfy the demands of users, mobile devices can usually perform wireless communication functions. Some devices cover a large wireless communication area; for example, mobile phones use 2G, 3G, and LTE (Long Term Evolution) systems and use frequency bands of 700 MHz, 850 MHz, 900 MHz, 1800 MHz, 1900 MHz, 2100 MHz, 2300 MHz, and 2500 MHz. Some devices cover a small wireless communication area; for example, mobile phones use Wi-Fi and Bluetooth systems and use frequency bands of 2.4 GHz, 5.2 GHz, and 5.8 GHz.

Current designers often dispose some metal elements on the surfaces of mobile devices for the convenience of users. However, these metal elements may negatively affect antenna elements which are built into mobile devices for wireless communication, and they may further degrade the communication quality of mobile devices.

### BRIEF SUMMARY OF THE INVENTION

In a preferred embodiment, the disclosure is directed to a mobile device including a housing, an antenna element, and a stylus. The stylus includes a first metal portion. When the stylus is close to the antenna element, the first metal portion resonates with the antenna element in an operation frequency band, so as to enhance the radiation efficiency of the antenna element.

In some embodiments, the length of the first metal portion is equal to 0.25 wavelength of a central operation frequency of the antenna element.

In some embodiments, the length of the antenna element is equal to 0.25 wavelength of a central operation frequency of the antenna element.

In some embodiments, a length difference between the antenna element and the first metal portion is from 0 mm to 20 mm.

In some embodiments, the housing is made of a nonconductive material.

In some embodiments, the mobile device further includes a magnetic element. The stylus is attracted by the magnetic element and is fixed on the housing.

In some embodiments, the stylus further includes a second metal portion. The first metal portion is closer to the antenna element than the second metal portion.

In some embodiments, the second metal portion is completely separated from the first metal portion by a nonmetallic region.

In some embodiments, the operation frequency band is from 780 MHz to 895 MHz.

In some embodiments, the length of the first metal portion is from 85 mm to 90 mm.

### BRIEF DESCRIPTION OF DRAWINGS

The invention can be more fully understood by reading the subsequent detailed description and examples with references made to the accompanying drawings, wherein:

FIG. 1 is a diagram of a mobile device according to an embodiment of the invention;

FIG. 2 is a diagram of a VSWR (Voltage Standing Wave Ratio) of an antenna element of a conventional mobile device;

FIG. 3 is a diagram of a VSWR of an antenna element of a mobile device according to an embodiment of the invention;

FIG. 4 is a diagram of a mobile device according to an embodiment of the invention;

FIG. 5 is a diagram of a mobile device according to an embodiment of the invention;

FIG. 6 is a diagram of a mobile device according to an embodiment of the invention; and

FIG. 7 is a diagram of a mobile device according to an embodiment of the invention.

### DETAILED DESCRIPTION OF THE INVENTION

In order to illustrate the purposes, features and advantages of the invention, the embodiments and figures of the invention are described in detail below.

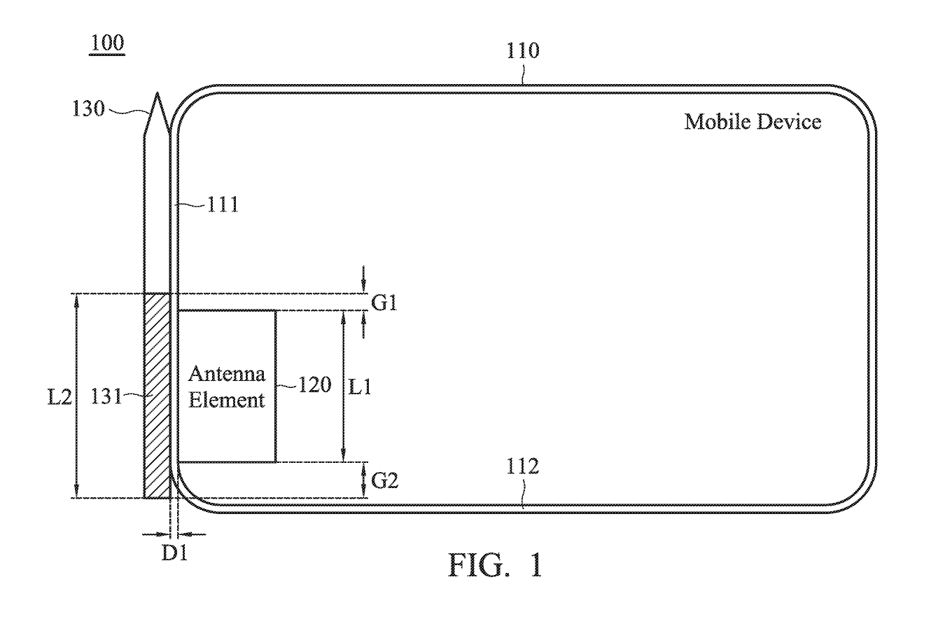

FIG. 1 is a diagram of a mobile device 100 according to an embodiment of the invention. The mobile device 100 may be a smartphone, a tablet computer, or a notebook computer. As shown in FIG. 1, the mobile device 100 at least includes a housing 110, an antenna element 120, and a stylus 130. The housing 110 may be made of a nonconductive material, such as a plastic material. The housing 110 may have a rectangular shape with a short edge 111 and a long edge 112. In the embodiment of FIG. 1, the antenna element 120 and the stylus 130 are close to the short edge 111 of the housing 110. The antenna element 120 is disposed inside the housing 110, and the stylus 130 is disposed outside the housing 110. The type of the antenna element 120 is not limited in the invention. For example, the antenna element 120 may be a monopole antenna, a dipole antenna, a loop antenna, a patch antenna, a helical antenna, a PIFA (Planar Inverted F Antenna), or a chip antenna. It should be understood that the mobile device 100 may further include other components, such as a display device, a wireless communication module, a battery, a processor, and a storage device (not shown).

A user can use the stylus 130 to input data via a touch control panel (not shown) of the mobile device 100. The stylus 130 may be passive or active, and it may include a battery element therein (not shown). In a preferred embodiment, the stylus 130 includes at least a first metal portion 131. The first metal portion 131 may be far away from a pen tip of the stylus 130, and may be positioned at one end of a pen holder of the stylus 130. When the stylus 130 is close to the antenna element 120 (e.g., the spacing D1 between the stylus 130 and the antenna element 120 is smaller than 10 mm but greater than 0 mm), the first metal portion 131 of the stylus 130 resonates with the antenna element 120 in an operation frequency band, so as to enhance the radiation efficiency of the antenna element 120. In some embodiments, the operation frequency band of the antenna element 120 and the first metal portion 131 of the stylus 130 is from 780 MHz to 895 MHz. In alternative embodiments, the aforementioned operation frequency band is from 700 MHz to 800 MHz, or from 2500 MHz to 2700 MHz.

As to the element sizes, the length L1 of the antenna element 120 is equal to 0.25 wavelength (λ/4) of a central operation frequency of the antenna element 120. The length L2 of the first metal portion 131 of the stylus 130 is also equal to 0.25 wavelength of the central operation frequency of the antenna element 120. In other words, the length L2 of the first metal portion 131 of the stylus 130 is substantially equal to the length L1 of the antenna element 120. However, the aforementioned lengths L1 and L2 are adjustable by designers, and they are not limited to the above. For example, if the antenna element 120 resonates with the first metal portion 131 of the stylus 130 in a frequency interval from 780 MHz to 895 MHz, the length L2 of the first metal portion 131 of the stylus 130 may be from 85 mm to 90 mm. The length L1 of the antenna element 120 may be also from 85 mm to 90 mm. In some embodiments, the length difference (i.e., |L1−L2| or G1+G2 as shown in FIG. 1) between the antenna element 120 and the first metal portion 131 of the stylus 130 is from 0 mm to 20 mm. That is, the length L2 of the first metal portion 131 of the stylus 130 may be slightly longer than the length L1 of the antenna element 120, or slightly shorter than the length L1 of the antenna element 120. Such a slight adjustment does not affect the performance of the invention so much.

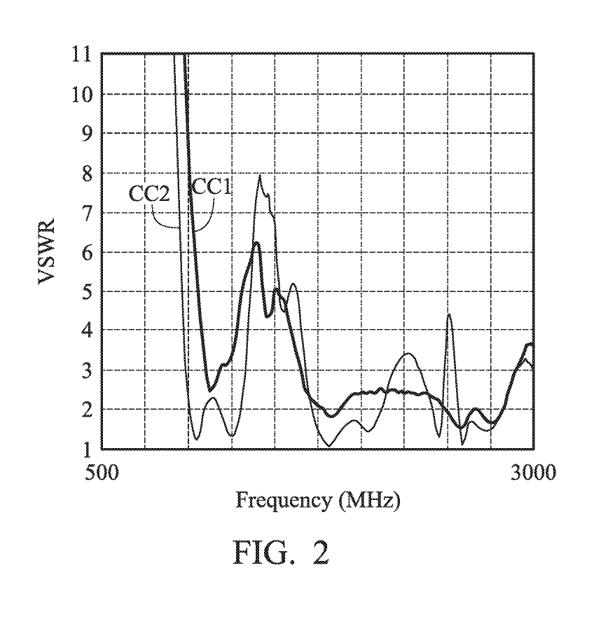

FIG. 2 is a diagram of a VSWR (Voltage Standing Wave Ratio) of an antenna element of a conventional mobile device. The horizontal axis represents operation frequency (MHz), and the vertical axis represents the VSWR. FIG. 2 is considered as a control group of the invention. As shown in FIG. 2, a first curve CC1 represents the operation that is characteristic of the antenna element of the mobile device without any stylus, and a second curve CC2 represents the operation that is characteristic of the antenna element of the mobile device with a whole metal stylus. The length of the whole metal stylus may be set to an arbitrary value. According to the measurement of FIG. 2, when the whole metal stylus is close to the antenna element, it affects the operation frequency band of the antenna element. The resonant frequency of the antenna element may shift, thereby degrading the antenna efficiency in the original operation frequency band.

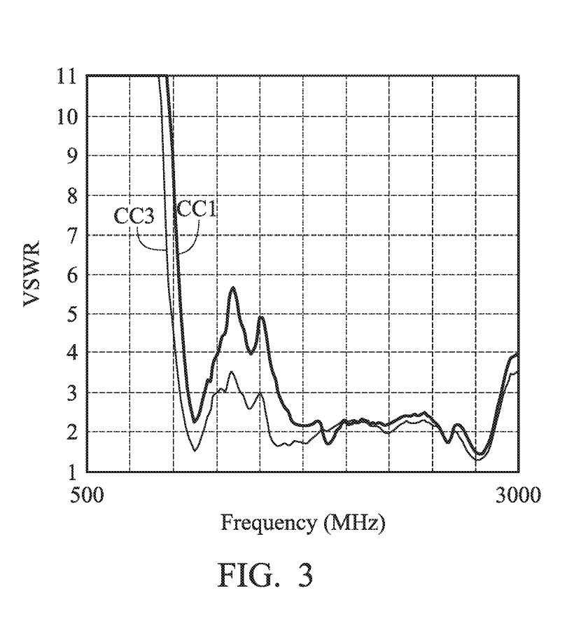

FIG. 3 is a diagram of a VSWR of the antenna element 120 of the mobile device 100 according to an embodiment of the invention. The horizontal axis represents operation frequency (MHz), and the vertical axis represents the VSWR. As shown in FIG. 3, a first curve CC1 represents the operation that is characteristic of the antenna element of the mobile device without any stylus, and a third curve CC3 represents the operation that is characteristic of the antenna element 120 of the mobile device 100 with the stylus 130 of FIG. 1. According to the measurement of FIG. 3, if the length L2 of the first metal portion 131 of the stylus 130 is appropriately designed (e.g., the length L2 may be set equal to 0.25 wavelength of the central operation frequency of the antenna element 120), the stylus 130 close to the antenna element 120 will not interfere with the radiation pattern of the antenna element 120. Conversely, the stylus 130 can improve the impedance matching of the antenna element 120 (i.e., the third curve CC3 of FIG. 3 is below the first curve CC1). In some embodiments, the antenna element 120 without the stylus 130 has antenna efficiency of about −3.12 dBi, and the antenna element 120 with the stylus 130 has antenna efficiency of about −2.45 dBi. That is, if the stylus 130 having an appropriate metal length is added, it can have a positive impact on the radiation characteristic of the antenna element 120. The first metal portion 131 of the stylus 130 can resonate with the antenna element 120, thereby guiding the radiation energy of the antenna element 120 to be transmitted outward.

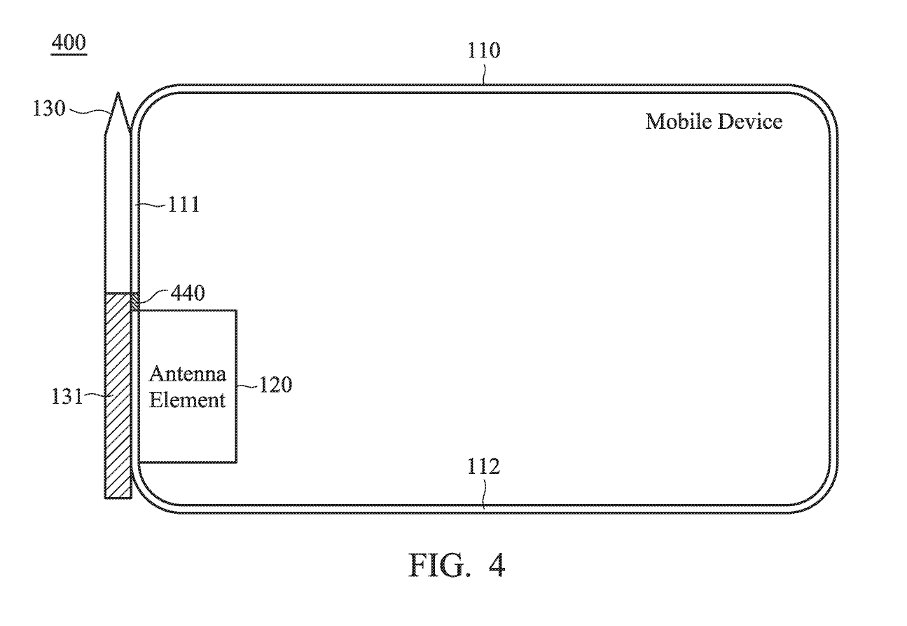

FIG. 4 is a diagram of a mobile device 400 according to an embodiment of the invention. FIG. 4 is similar to FIG. 1. In the embodiment of FIG. 4, the mobile device 400 further includes a magnetic element 440, which may be embedded in the short edge 111 of the housing 110. The magnetic element 440 may have a circular shape, a rectangular shape, a parallelogram shape, or a trapezoidal shape. The stylus 130 is attracted by the magnetic element 440 and is fixed on the housing 110. According to practical measurements, the magnetic element 440 almost has no impact on the operation that is characteristic of the antenna element 120, and therefore its interference is negligible. Other features of the mobile device 400 of FIG. 4 are similar to those of the mobile device 100 of FIG. 1. Therefore, the two embodiments can achieve similar levels of performance.

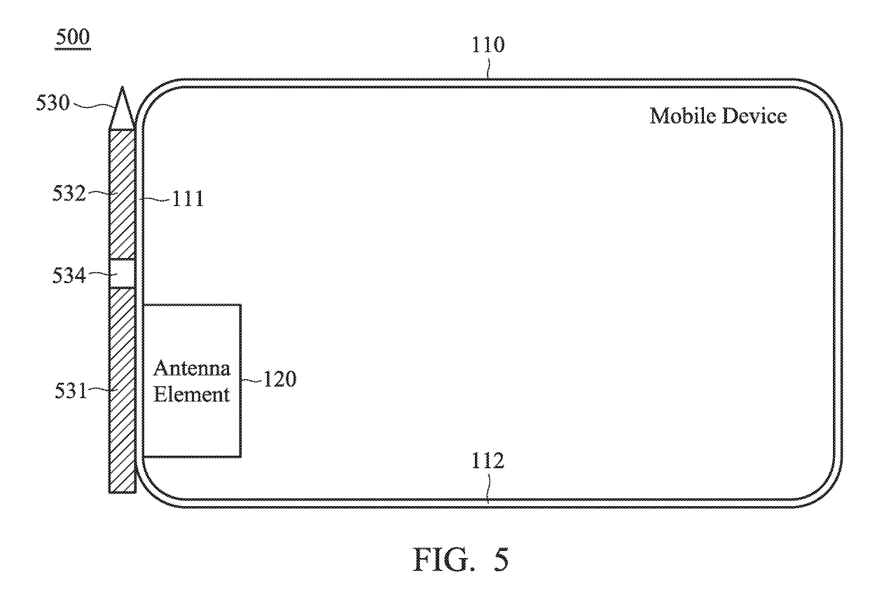

FIG. 5 is a diagram of a mobile device 500 according to an embodiment of the invention. FIG. 5 is similar to FIG. 1. In the embodiment of FIG. 5, a stylus 530 of the mobile device 500 includes a first metal portion 531 and a second metal portion 532. The second metal portion 532 is completely separated from the first metal portion 531 by a nonmetallic region 534. The first metal portion 531 is closer to the antenna element 120 than the second metal portion 532. Since the antenna element 120 resonates with the first metal portion 531 of the stylus 530, the length of the first metal portion 531 of the stylus 530 should be equal to 0.25 wavelength of the central operation frequency of the antenna element 120, but the length of the second metal portion 532 of the stylus 530 is not limited. By using the nonmetallic region 534 to divide metal regions on the stylus 530, a designer can easily obtain a proper metal length for resonation with the antenna element 120. Other features of the mobile device 500 of FIG. 5 are similar to those of the mobile device 100 of FIG. 1. Therefore, the two embodiments can achieve similar levels of performance.

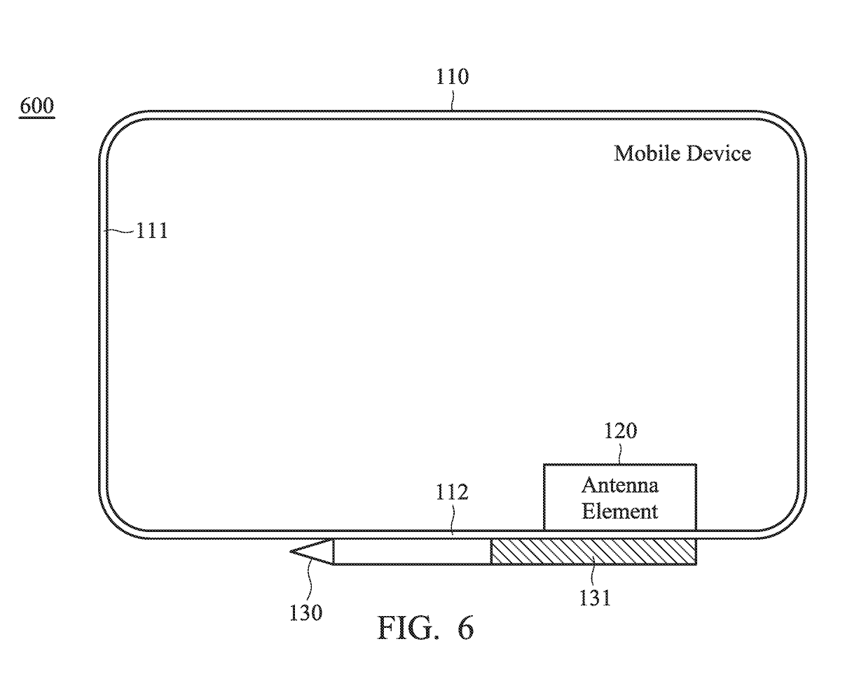

FIG. 6 is a diagram of a mobile device 600 according to an embodiment of the invention. FIG. 6 is similar to FIG. 1. In the embodiment of FIG. 6, the antenna element 120 and the stylus 130 are both close to the long edge 112 of the housing 110, and are separated by the long edge 112 of the housing 110. In alternative embodiments, the antenna element 120 and the stylus 130 are close to any edge of the housing 110. Other features of the mobile device 600 of FIG. 6 are similar to those of the mobile device 100 of FIG. 1. Therefore, the two embodiments can achieve similar levels of performance.

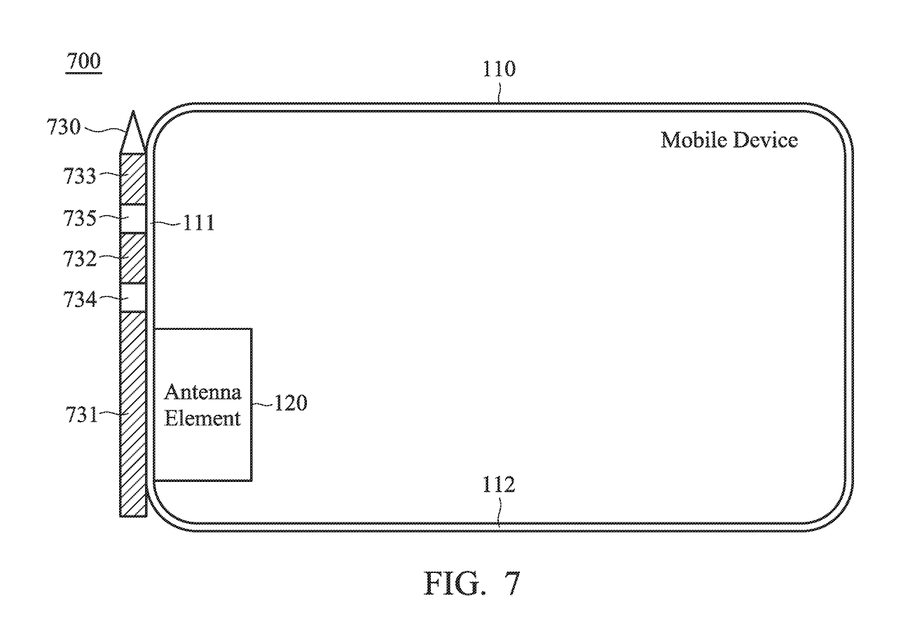

FIG. 7 is a diagram of a mobile device 700 according to an embodiment of the invention. FIG. 7 is similar to FIG. 1. In the embodiment of FIG. 7, a stylus 730 of the mobile device 700 includes a first metal portion 731, a second metal portion 732, and a third metal portion 733. The second metal portion 732 is completely separated from the first metal portion 731 by a first nonmetallic region 734. The third metal portion 733 is completely separated from the second metal portion 732 by a second nonmetallic region 735. The first metal portion 731 is closer to the antenna element 120 than the second metal portion 732 and the third metal portion 733. Since the antenna element 120 resonates with the first metal portion 731 of the stylus 730, the length of the first metal portion 731 of the stylus 730 should be equal to 0.25 wavelength of the central operation frequency of the antenna element 120, but the length of the second metal portion 732 of the stylus 730 and the length of the third metal portion 733 of the stylus 730 are not limited. By using the first nonmetallic region 734 and the second nonmetallic region 735 to divide metal regions on the stylus 730, a designer can easily obtain the proper metal length for resonation with the antenna element 120. Other features of the mobile device 700 of FIG. 7 are similar to those of the mobile device 100 of FIG. 1. Therefore, the two embodiments can achieve similar levels of performance.

The invention proposes a novel mobile device and an antenna element therein, so as to prevent a stylus from interfering with the antenna element. By adjusting the length of the metal portion of the stylus, the metal portion can resonate with the antenna element, and the radiation energy of the antenna element can be guided and transmitted outward due to the mutual coupling therebetween. Accordingly, the stylus does not negatively affect the characteristics of the antenna element, and furthermore, it effectively enhances the radiation efficiency of the antenna element. As a result, the invention is suitable for application in a variety of mobile devices with styluses.

Note that the above element sizes, element shapes, and frequency ranges are not limitations of the invention. A designer can adjust these settings or values according to different requirements. It should be understood that the mobile device of the invention is not limited to the configurations of FIGS. 1-7. The invention may merely include any one or more features of any one or more embodiments of FIGS. 1-7. In other words, not all of the features shown in the figures should be implemented in the mobile device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with the true scope of the disclosed embodiments being indicated by the following claims and their equivalents.

What is claimed is:

1. A mobile device, comprising:
a housing;
an antenna element; and
a stylus, comprising a first metal portion, wherein when the stylus is close to the antenna element, the first metal portion resonates with the antenna element in an operation frequency band, so as to enhance radiation efficiency of the antenna element.

2. The mobile device as claimed in claim 1, wherein a length of the first metal portion is equal to 0.25 wavelength of a central operation frequency of the antenna element.

3. The mobile device as claimed in claim 1, wherein a length of the antenna element is equal to 0.25 wavelength of a central operation frequency of the antenna element.

4. The mobile device as claimed in claim 1, wherein a length difference between the antenna element and the first metal portion is from 0 mm to 20 mm.

5. The mobile device as claimed in claim 1, wherein the housing is made of a nonconductive material.

6. The mobile device as claimed in claim 1, further comprising:
a magnetic element, wherein the stylus is attracted by the magnetic element and is fixed on the housing.

7. The mobile device as claimed in claim 1, wherein the stylus further comprises a second metal portion, and the first metal portion is closer to the antenna element than the second metal portion.

8. The mobile device as claimed in claim 7, wherein the second metal portion is completely separated from the first metal portion by a nonmetallic region.

9. The mobile device as claimed in claim 1, wherein the operation frequency band is from 780 MHz to 895 MHz.

10. The mobile device as claimed in claim 1, wherein a length of the first metal portion is from 85 mm to 90 mm.
